(19) United States
(12) Patent Application Publication
(10) Pub. No.: US 2007/0006050 A1
(43) Pub. Date: Jan. 4, 2007

(54) Automatic notification of applicable bulletins and tags based on fault analysis

(75) Inventor: Susan B. Layer, Fairport, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/169,716

(22) Filed: Jun. 30, 2005

(51) Int. Cl. G06F 11/00

(52) U.S. Cl. 714/44

(57) ABSTRACT

Systems, methods, and programs determine a fault on a device using a diagnostic agent. The systems, methods, and programs determine at least one service information associated with the fault, assigning the service bulletin to the fault, and displaying the service information associated with the fault. The systems, methods, and programs also includes identifying at least one fault in a device connected to a server, transmitting service information to the device, determining whether service information stored on the server corresponds to the fault, and assigning the corresponding service information to the fault.

### BACKGROUND

1. Related Technical Fields

Related technical fields include systems and methods of providing service information.

2. Related Art

In conventional devices, such as, for example, a printer, a server, a copier, a computer, a scanner, a facsimile device, imaging device, and other devices, a fault in the device may occur that causes the device to operate at less than full capacity or to become inoperable. When the fault occurs in the device, a field service person and/or service representative is typically notified. Conventionally, the service representative evaluates the device to determine the fault and then repairs the fault using service information that corresponds to that particular fault.

### SUMMARY

Conventionally, either the service information or a part required to fix the fault in the device is not readily available to the service representative out in the field. This can result in the service representative having to leave the device in order to retrieve the required service information and/or spend time searching for the right information to fix the fault in the device.

In order to repair a fault in a device, a service representative must obtain the appropriate service information to the fault. However, for example, the service representative may not have all the pertinent service information available in the field at the time the service representative is fixing the fault. The service information that is available to the service representative may not correspond to the particular fault identify by the device. Further, there may be too much service information available for service representative to efficiently locate the appropriate service information corresponding to the particular fault. Any one of the above scenarios may result in a delay in fixing the device while the service representative searches for the appropriate service information. The delay may result in loss productivity while the device is inoperable, increase cost, and poor customer relations.

Accordingly, it is beneficial to have current service information corresponding to the identified fault available to the service representative.

Various implementations of the principles described herein include a method for automatic service notification. The method may include identifying at least one fault in a device connected to a server, retrieving service information and/or transmitting the fault to the server, determining whether service information received and/or stored on the server corresponds to the fault, storing the received service information in memory and/or on a hard drive or other suitable information storage medium, and assigning the corresponding service information to the fault.

Various implementations of the principles described herein include a device for automatic service notification. The device may include a device in communication with a network. The device may include a controller that includes a diagnostic capability to determine at least one fault, a server connected to the controller, the server including service information, a memory for storing at least one of a fault and/or the service information, and a data processing program that is stored in the memory and based on the fault provided by the controller, determines whether service information transmitted by the server corresponds to the fault and associates the service information to the fault.

Various implementations of the principles described herein include a storage medium storing a set of program instructions executable on a data processing device and usable to determine service information on a network that corresponds to a fault. The instructions may include instructions for identifying at least one fault in a device connected to a server, receiving service information and/or transmitting the fault to the server, determining whether service information received and/or stored on the server corresponds to the fault, storing the received service information in a memory, and assigning the corresponding service information to the fault.

### BRIEF DESCRIPTION OF THE DRAWINGS

Exemplary implementations will now be described with references to the accompanying drawings, wherein:

FIG. 1 shows a method of retrieving bulletins and assigning bulletins to faults according to an exemplary implementation of the principles described herein;

FIG. 2 shows a method of retrieving bulletins to a device according to an exemplary implementation of the principles described herein; and

FIG. 3 shows a functional block diagram of an exemplary system for determining the bulletin corresponding to the fault.

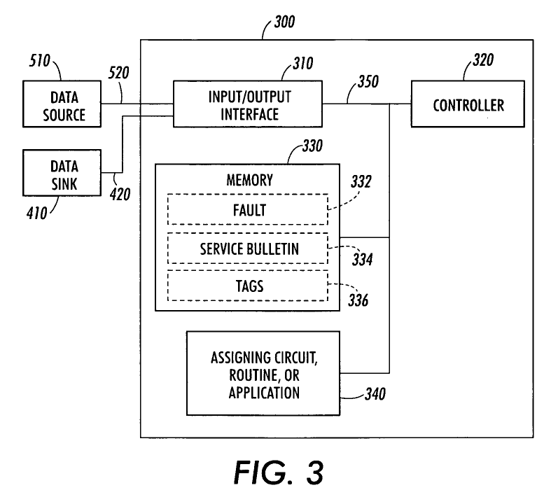

### DETAILED DESCRIPTION OF EMBODIMENTS

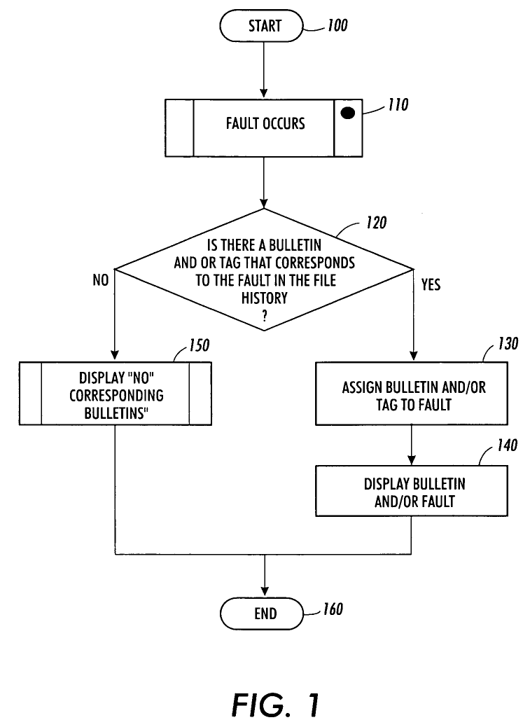

FIG. 1 shows an exemplary method of retrieving at least one and possibly more than one service information, for example service bulletin and/or retrofit information (tags), directly to a device and/or device in the field and assigning the service information to a fault. The device may be, for example, a printer, a facsimile device, a xerographic device, a xerographic color printer, a digital photocopier, a marking device, multi-functional imaging device, a scanning device, and the like. The device may be in a remote location, for example, in an office building or any other location where the device is considered located in the field. It will be appreciated that a remote location includes any location a field service personnel and/or service representative may be notified to service the device. The device may be a customer device, such as, for example, a customer xerographic device.

The exemplary method begins in step 100 and continues to step 110. In step 110, it is determined whether there is new information available at a server, for example a service bulletin server. The new information may be information such as, for example, service information, service bulletins, and retrofit information (tags). The device queries the server, for example the service bulletin server, for new information. The service bulletin server may be connected to the device, for example, directly or remotely. The device, for example, may be a printer connected to a printer server. Alternatively, another server, for example, the printer server, may query the service bulletin server. The printer server may be, for example, connected to the printer directly or remotely. A network system may be provided so that the device, for example, the printer can communicate with the service bulletin server and/or the printer server. The network system may automatically download information, such as, for example, service bulletins and tags to a customer device.

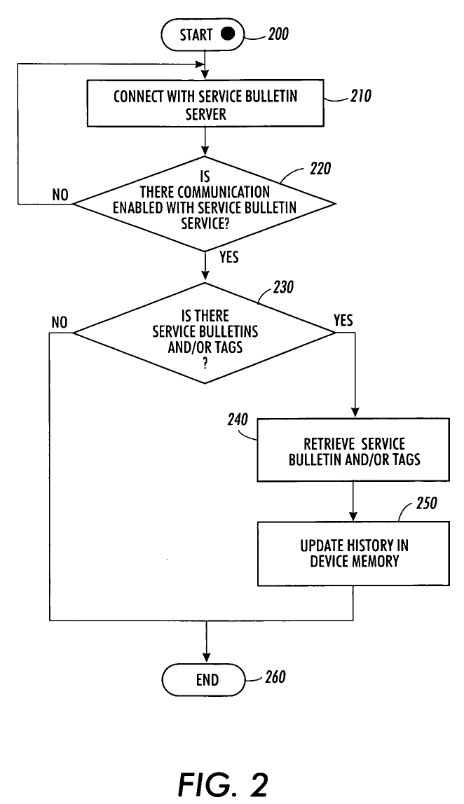

The service bulletin server may be located remotely and/or locally from the printer server. The service bulletin server may be a repository for all service bulletins and may be a common server in communication with a plurality of print servers or devices and include service bulletins and/or tags and other information that is considered pertinent to service information. The service bulletin server may be in communication with the device via wireless communication. The query may be performed, for example, by the exemplary method of FIG. 2.

During operation of the device, a fault occurs in the device. The fault is stored in the device. The fault history will then be analyzed for applicability. The faults may be a particular problem or plurality of problems that cause the device to operate at less than full capacity and/or efficiency. The fault may be such that the device is inoperable. The fault may be determined, for example, by the device that may include a diagnostic capability. Alternatively, the device may be connected to a network, which enables the device to analyze a fault and/or fault patterns and to connect the faults discovered to applicable service bulletins and/or tags on the network that may be downloaded to the device. Also, more than one fault may be determined from the fault analysis. If there is no fault, operation continues to step 110. For example, the device may perform periodical diagnostic to determine a fault and fault patterns or perform a diagnostic when a fault is determined. If there is a fault, operation continues to step 120.

In step 120, it is determined whether there is service information, for example, a service bulletin and/or retrofit information (tag) that corresponds to any of the historical faults stored on the device. More than one service bulletin and/or tag may correspond to a particular fault. The service bulletins and tags may be stored in memory, for example, in the printer memory. If a bulletin and/or tag correspond to the particular fault, operation continues to step 130. If the bulletin and/or tag does not correspond to the fault, operation jumps to step 150.

In step 130, the bulletin and/or tag is assigned to the fault. It is possible that more than one bulletin and tag can be assigned to the fault. Operation continues step 140.

In step 140, the service bulletin and/or tag is displayed. The service bulletin may be display by the device, such as, for example, on a display screen. The service bulletin may be displayed as an icon where the service representative can access the information. Also, the service bulletin may be displayed with the corresponding fault so that the service representative can access both the service bulletin and the fault at the same time. For example, the display screen may be capable of displaying more than one icon at the same time. By displaying multiple information relating to the fault the service representative may more quickly diagnose and fix the fault. Operation continues step 160, where operation of the method ends.

In step 150, the device, such as, for example on a display screen, displays that no corresponding service bulletins and/or tags are associated with the fault. Operation continues to step 160, where the operation of the method ends.

FIG. 2 shows an exemplary method of assigning and/or retrieving at least one and possibly more than one type of information, for example new and/or updated service information, such as, service bulletin and/or retrofit information (tags) to a device and/or fault at the device

Operation of the method begins in step 200 and continues to step 210 where the device, for example the printer device, connects with a server, for example, the service bulletin server. Operation continues to step 220.

In step 220, it is determined whether communication is enabled with the service bulletin server. If communication is not enabled, operation reverses to step 210. If communication is enabled, operation continues to step 230.

In step 230, it is determined whether there is new service information, for example, a service bulletin and/or tag. The new service information may also correspond to a particular fault detected. More than one service bulletin and/or tag may correspond to a particular fault. The service bulletins and/or tags may be stored in a memory, for example, in a memory of the service bulletin server. Alternatively, the service bulletin server may determine if a service bulletin and/or tag correspond to the particular fault. Operation continues to step 240.

In step 240, the new service information is retrieved. Also, for example, any service bulletins and/or tags from the service bulletin server associated with any faults are retrieved. It is possible that more than one service bulletin and/or tag can be assigned to the fault. It is also possible that more than one service bulletin and/or tag may be retrieved simultaneously. Operation continues step 250.

In step 250, the file history in the device memory is updated with the service information retrieved from the service bulletin server. Operation continues step 260, where operation of the method ends.

FIG. 6 shows a functional block diagram of an exemplary of a system 300 for automatic service notification that may be used, for example, to implement one or more of the above described exemplary methods. As shown in FIG. 6, the system 300 may be physically, functionally, and/or conceptually divided into an input/output interface 310, a controller 320, a memory 330, and/or a assigning circuit, routine, or application 340, each appropriately interconnected by one or more data/control busses and/or application programming interfaces 350, or the like.

The input/output interface 310 may be connected to one or more data sources 510 over one or more links 520. The data source(s) 510 can be a locally or remotely located device that stores and/or transmits electronic data, such as a client or a server of a wired or wireless network, such as, for example, an intranet, an extranet, a local area network, a wide area network, a storage area network, the Internet (especially the World Wide Web), and the like. In general, the data source 510 can be any known or later-developed source that is capable of providing data, such as, for example, a fault data and/or service data to the input/output interface 310.

The input/output interface 310 may be connected to one or more data sinks 410 over one or more links 420. The data sink(s) 410 can be a locally or remotely located device, for example a printer, a facsimile device, a xerographic device, a xerographic marking device, a xerographic color printer, a digital photocopier, a marking device, a multi-functional imaging device, a device that stores and/or transmits electronic data, such as a client or a server of a wired or wireless network, such as, for example, an intranet, an extranet, a local area network, a wide area network, a storage area network, the Internet (especially the World Wide Web), and the like. In general, the data sink 410 can be any known or later-developed source that is capable of utilizing and/or determining service data, such as, for example service bulletin data or service tag data provided by the input/output interface 310.

Each of the various links 420 and 520 may be any known or later-developed device or system for connecting the data source(s) 410 and/or the data sink(s) 510, respectively, to the input/output interface 310. In particular, the links 420 and 520 may each be implemented as one or more of, for example, a direct cable connection, a connection over a wide area network, a local area network or a storage area network, a connection over an intranet, a connection over an extranet, a connection over the Internet, a connection over any other distributed processing network or system, and/or an infrared, radio-frequency or other wireless connection.

As shown in FIG. 6, the memory 330 may be physically, functionally, and/or conceptually divided into a number of different memory portions, including a fault portion 332, a service bulletin portion 334, and/or a retrofit information (tags) portion 336. The fault portion 332 may store the fault data such as, for example, the different faults and the attributes of the faults within a fault log. The service bulletin portion 334 may store one or more service bulletins. The tag portion 336 may store one or more tags, for example, the tags may be different kinds of retrofit information.

The memory 330 may be implemented using any appropriate combination of alterable or non-alterable memory, volatile or non-volatile memory, or fixed memory. The alterable memory, whether volatile or non-volatile, can be implemented using any one or more of static or dynamic RAM, a floppy disk and disk drive, a writeable or re-re-writeable optical disk and disk drive, a hard drive, flash memory or the like. Similarly, the non-alterable or fixed memory can be implemented using any one or more of ROM, PROM, EPROM, EEPROM, an optical ROM disk, such as CD-ROM or DVD-ROM disk, and disk drive or the like.

The assigning circuit, routine, or application 340 may input data related to, for example, a fault, a service bulletin, and a tag and determine and assign a service bulletin and/or tag to a fault based on the input data, for example, assigning one or more corresponding service bulletins and tags to a specific fault based on the diagnostic data.

For example, in operation, data related to a fault (fault data and/or fault log) may be input from the data source to the input/output interface 310. Under control of the controller 320, the data, such as, for example, service bulletins and/or retrofit information (tags), may be stored in the service bulletin portion 334 and tag portion 336 of the memory 330, respectively. Alternatively, the service bulletin and/or tag data may be input, under control of the controller 320, directly to assigning circuit, routine, or application 340. Under control of the controller, the assigning, routine, or application 340 may access the fault data and/or fault log, the service bulletin and/or tag data and assign one or more service bulletins and/or tags associated with the fault data. Under control of the controller 320, the fault may be stored in the fault portion 332. Alternatively, the fault data may be input, under control of the controller 320, directly to the assigning circuit, routine, or application 340.

Under control of the controller 320, the assigned service bulletin and/or tag may be output to the data sink 410 via the input/output interface 310. Accordingly, the various faults and corresponding assigned service bulletins and/or tags may be utilized by a remote network services in order to more efficiently automatically download critical service bulletins and retrofit information (tags) directly to the various device in the field. This may be done, for example, by the exemplary method shown in FIGS. 1-2.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

For example, according to various other exemplary implementations, an automatic service representation notification network is configured to automatically download service bulletins and/or tags to the various devices in the field based on a fault identified by, for example, a diagnostic agent under the control of the controller. Under the control of the controller, assigning circuit, routine, or application assigns corresponding service information to the fault data.

Furthermore, for example, one or more service bulletins and/or tags, in addition to assigned service bulletins and/or tags, may be considered with the fault. The order in which the various service bulletins and tags are assigned to a corresponding fault may be changed.

While the exemplary system has been described as physically, functionally, and/or conceptually divided into an assigning circuit, routine, or application 340, it should be appreciated that one or more of the circuits, routines, or applications may be included in and/or executed by the controller 320.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A device for automatic service notification, comprising:
a controller that:
includes a diagnostic capability to determine at least one fault;
a server connected to the controller, the server including service information;
a memory for storing at least one of the fault and the service information; and
a data processing program that is stored in the memory and based on the fault provided by the controller, determines whether service information transmitted by the server corresponds to the fault, and associates the service information to the fault.

2. The device for automatic service notification according to claim 1, wherein the service information includes at least one service bulletin.

3. The device for automatic service notification according to claim 1, wherein the service information includes at least one tag.

4. The device for automatic service notification according to claim 1, further comprising a display device connected to the controller for displaying the service information.

5. The device for automatic service notification according to claim 4, wherein at least one of the service information and the fault is displayed as an icon.

6. The device for automatic service notification according to claim 4, wherein the service information and the fault are displayed simultaneously.

7. The device for automatic service notification according to claim 1, wherein the fault is transmitted to the server.

8. The device for automatic service notification according to claim 1, wherein the device is a xerographic marking device.

9. A method for automatic service notification, comprising:
at least one of transmitting and receiving service information to a device connected to a server;
identifying at least one fault in the device;
determining whether service information stored on the device corresponds to the fault; and
assigning the corresponding service information to the fault.

10. The method for automatic service notification according to claim 9, wherein the corresponding service information includes at least one tag.

11. The method for automatic service notification according to claim 9, wherein the corresponding service information includes at least on service bulletin.

12. The method for automatic service notification according to claim 9, further comprising displaying the corresponding service information.

13. The method for automatic service notification according to claim 12, wherein the corresponding service information and identified fault are displayed simultaneously.

14. The method for automatic service notification according to claim 12, wherein the corresponding service information and identified fault are displayed simultaneously as at least one icon.

15. The method for automatic service notification according to claim 12, wherein the corresponding service information is displayed as an icon.

16. The method for automatic service notification according to claim 9, further comprising transmitting the fault to the server.

17. The method for automatic service notification according to claim 16, further comprising determining whether service information stored on the server corresponds to the fault.

18. A xerographic marking device incorporating the method for automatic service notification of claim 9.

19. A storage medium storing a set of program instructions executable on a data processing device and usable to determine a service information on a network, the instructions comprising:
instructions for identifying at least one fault in a device connected to a server;
instructions for at least one of transmitting and receiving service information to the device;
instructions for determining whether service information stored on the server corresponds to the fault; and
instructions for assigning the corresponding service information to the fault.

20. The storage medium according to claim 19, further comprising instructions for displaying at least one of the corresponding service information and identified fault.
